(19) United States
(12) Patent Application Publication
(10) Pub. No.: US 2017/0197341 A1
(43) Pub. Date: Jul. 13, 2017

(54) SYSTEM AND METHOD FOR POWDER COATING PARTS FORMED VIA ADDITIVE MANUFACTURING

(71) Applicant: HONEYWELL FEDERAL MANUFACTURING & TECHNOLOGIES, LLC, Kansas City, MO (US)

(72) Inventors: HOWARD LESLIE WEINICK, WARNER ROBINS, GA (US); MICHAEL DON HESTER, PLEASANT HILL, MO (US)

(73) Assignee: HONEYWELL FEDERAL MANUFACTURING & TECHNOLOGIES, LLC, Kansas City, MO (US)

(21) Appl. No.: 14/990,534

(22) Filed: Jan. 7, 2016

(51) Int. Cl. B29C 37/00; B33Y 10/00; B33Y 40/00; G05D 23/19; B05D 7/00; B05D 3/02; B05D 5/00; B05B 5/16; B29C 67/00; B33Y 50/02

(52) U.S. Cl. CPC B29C 37/0025; B29C 67/0051; B29C 67/0088; B33Y 10/00; B33Y 40/00; B33Y 50/02; B05D 7/544; B05D 3/0272; B05D 5/00; B05D 3/0263; B05B 5/1683; G05D 23/19; B29K 2077/00

(57) ABSTRACT

A system and method for forming a part via additive manufacturing and powder coating the part. The system comprises an additive manufacturing system and a powder coating system. The additive manufacturing system includes a frame, support surface, material reserve, feeder, material applicator, a set of motors, and a processor. The additive manufacturing system produces a part core formed of a non-conductive low melting point material according to a computer aided design. The powder coating system includes a primer applicator, powder coating applicator, and curing apparatus. The material applicator applies a conductive primer to an outer surface of the part core. The conductive primer is then air dried. The powder coating applicator applies an electrostatically charged powder coating to the conductive primer. The curing apparatus then cures the powder coating and conductive primer without the temperature of the core of the part reaching the non-conductive low melting point material melting point.

### BACKGROUND

Additive manufacturing is often used for creating prototypes and unique, complex, and/or low-production parts. Such parts are often formed of non-conductive and/or low melting point materials such as plastics, polymers, and similar materials for their low cost, availability, effective strength, and superior ease with which they can be selectively sintered and/or bonded to previously bonded layers of material. However, these materials are susceptible to ultraviolet light and surface damage (e.g., abrasion) and are available in only a few colors. Liquid paint and electrostatic powder coating are often used to provide ultraviolet light resistance, abrasion resistance, and color variation to parts made of metal, wood, and other materials. However, solvents in liquid paint chemically degrade the outer surface of parts formed of non-conductive and/or low melting point materials. Powder coating does not have these solvents but cannot be applied electrostatically to non-conductive materials. Powder coating is also typically cured at temperatures that would melt or structurally compromise low melting point materials such as plastic and polymers.

### SUMMARY OF THE INVENTION

The present invention solves the above-described problems and provides a distinct advance in the art of additive manufacturing. More particularly, the present invention provides an additive manufacturing and powder coating system and method for powder coating a part formed of non-conductive low melting point material via additive manufacturing that does not chemically degrade the outer surface of the part and does not melt or structurally compromise the part when the powder coating is cured.

An embodiment of the present invention is an additive manufacturing and powder coating system broadly including an additive manufacturing system and a powder coating system having a primer applicator, a powder coating applicator, and a curing apparatus.

The additive manufacturing system produces a part (e.g., a prototype, special-order part, complex part) according to a computer-aided design and may include a frame, a support surface, a material reserve, a feeder, a material applicator, a set of motors, and a processor. The frame supports the above components. The support surface may be mounted on the frame and supports the part as the part is being constructed. The material reserve retains a supply of non-conductive low melting point material. The feeder feeds non-conductive low melting point material from the material reserve to the material applicator. The material applicator deposits the non-conductive low melting point material onto the support structure, layer by layer, while the motors move the material applicator in relation to the part. The processor directs movement of the applicator and activation of the feeder according to the computer-aided design so that material is deposited on the support surface, and then on previously constructed layers, as required.

Use of the additive manufacturing and powder coating system will now be summarized. First, a computer aided design of the part may be generated via additive manufacturing design software. The non-conductive low melting point polymer may then be stocked in or on the material reserve. The feeder may then draw some of the material from the material reserve and the material applicator may then deposit the material onto the support surface and previously constructed layers. The motors, as controlled by the processor, may move and position the applicator so that the material forms the part according to the computer-aided design of the part.

The primer applicator of the powder coating system may then apply a layer of conductive primer onto an outer surface of the part. The conductive primer may then be air dried. The powder coating applicator may then apply a layer of electrostatically charged powder coating onto the conductive primer layer so that the powder coating electrostatically bonds to the conductive primer. The curing apparatus may then cure the powder coating and conductive primer while retaining the core of the part at a temperature below a melting point of the non-conductive low melting point material so that the powder coating chemically bonds to the primer without the core of the part melting or being structurally compromised.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present invention will be apparent from the following detailed description of the embodiments and the accompanying drawing figures.

### BRIEF DESCRIPTION OF THE DRAWING FIGURES

Embodiments of the present invention are described in detail below with reference to the attached drawing figures, wherein:

FIG. 1 is a perspective view of an additive manufacturing and powder coating system constructed in accordance with an embodiment of the present invention;

FIG. 2 is a partial cut-away view of a part formed via the additive manufacturing and powder coating system of FIG. 1 being coated with a conductive primer in accordance with an embodiment of the present invention;

FIG. 3 is a partial cut-away view of the part of FIG. 2 being coated with a powder coating in accordance with an embodiment of the present invention;

FIG. 4 is a partial cut-away view of the part of FIGS. 1 and 2 being cured in accordance with an embodiment of the present invention; and

FIG. 5 is a flow chart of a method of forming and powder coating a part via the additive manufacturing and powder coating system of FIG. 1.

The drawing figures do not limit the present invention to the specific embodiments disclosed and described herein. The drawings are not necessarily to scale, emphasis instead being placed upon clearly illustrating the principles of the invention.

### DETAILED DESCRIPTION OF THE EMBODIMENTS

The following detailed description of the invention references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the present invention. The following detailed description is, therefore, not to be taken in a limiting sense. The scope of the present invention is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the current technology can include a variety of combinations and/or integrations of the embodiments described herein.

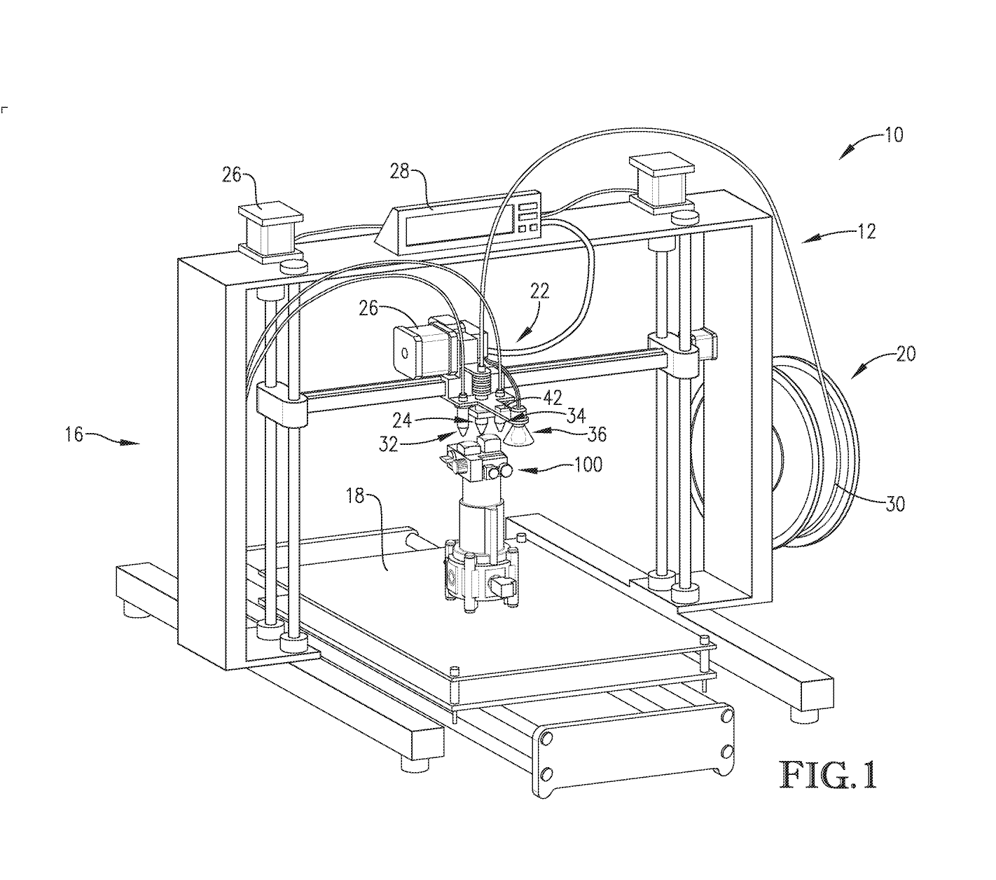

Turning to the drawing figures, and particularly FIGS. 1-4, an additive manufacturing and powder coating system 10 constructed in accordance with an embodiment of the present invention is illustrated. The additive manufacturing and powder coating system 10 broadly comprises an additive manufacturing system 12 and a powder coating system 14.

The additive manufacturing system 12 produces prototypes and parts such as part 100 and broadly includes a frame 16, support surface 18, a material reserve 20, a feeder 22, a material applicator 24, set of motors 26, and a processor 28. The additive manufacturing system 12 may be integral with or separate from the powder coating system 14.

The frame 16 provides structure for the support surface 18, material reserve 20, feeder 22, material applicator 24, motors 26, and/or the processor 28 and may include a base, vertical members, cross members, and mounting points for mounting the above components thereto. Alternatively, the frame 16 may be a walled housing or similar structure.

The support surface 18 supports the part 100 as it is being constructed and may be a stationary or movable flat tray or bed, a substrate, a mandrel, a wheel, scaffolding, or similar support. The support surface 18 may be integral with the additive manufacturing system 12 or may be removable and transferable with the part 100 as the part 100 is being constructed.

The material reserve 20 retains non-conductive low melting point material 30 and may be a hopper, tank, cartridge, container, spool, or other similar material holder. The material reserve may be integral with the additive manufacturing system 12 or may be disposable and/or reusable.

The non-conductive low melting point material 30 may be used for forming a core 102 of the part 100 and may be in pellet or powder form, filament or spooled form, or any other suitable form. The non-conductive low melting point material 30 may be any plastic, polymer, or organic material suitable for use in additive manufacturing. For example, the non-conductive low melting point material 30 may be acrylonitrile butadiene styrene (ABS), polyamide, straw-based plastic, or other similar material.

The feeder 22 directs the non-conductive low melting point material 30 to the material applicator 24 and may be a spool feeder, a pump, an auger, or any other suitable feeder. Alternatively, the non-conductive low melting point material 30 may be gravity fed to the material applicator 24.

The material applicator 24 deposits the non-conductive low melting point material 30 onto the support surface 18 and previously constructed layers. The material applicator 24 may include a nozzle, guide, sprayer, or other similar component for channeling the non-conductive low melting point material 30 and a laser, heater, or similar component for melting the non-conductive low melting point material and bonding (e.g., sintering) the non-conductive low melting point material onto a previously constructed layer. The material applicator 24 may be sized according to the size of the pellets, powder, or filament being deposited.

The motors 26 position the material applicator 24 over the support surface 18 and previously constructed layers and move the material applicator 24 as the non-conductive low melting point material is deposited onto the support surface 18 and the previously constructed layers. The motors 26 may be oriented orthogonally to each other so that a first one of the motors 26 is configured to move the material applicator 24 in a lateral “x” direction, a second one of the motors 26 is configured to move the material applicator 24 in a longitudinal “y” direction, and a third one of the motors 26 is configured to move the material applicator 24 in an altitudinal “z” direction. Alternatively, the motors 26 may move the support surface 18 (and hence the part 100) while the material applicator 24 remains stationary.

The processor 28 directs the material applicator 24 via the motors 26 and activates the material applicator 24 such that the material applicator 24 deposits the non-conductive low melting point material 30 onto the support surface 18 and previously constructed layers according to a computer aided design of the part. The processor 28 may include a circuit board, memory, display, inputs, and/or other electronic components such as a transceiver or external connection for communicating with external computers and the like.

The processor 28 may implement aspects of the present invention with one or more computer programs stored in or on computer-readable medium residing on or accessible by the processor. Each computer program preferably comprises an ordered listing of executable instructions for implementing logical functions in the processor 28. Each computer program can be embodied in any non-transitory computer-readable medium for use by or in connection with an instruction execution system, apparatus, or device, such as a computer-based system, processor-containing system, or other system that can fetch the instructions from the instruction execution system, apparatus, or device, and execute the instructions. In the context of this application, a “computer-readable medium” can be any non-transitory means that can store the program for use by or in connection with the instruction execution system, apparatus, or device. The computer-readable medium can be, for example, but not limited to, an electronic, magnetic, optical, electro-magnetic, infrared, or semi-conductor system, apparatus, or device. More specific, although not inclusive, examples of the computer-readable medium would include the following: an electrical connection having one or more wires, a portable computer diskette, a random access memory (RAM), a read-only memory (ROM), an erasable, programmable, read-only memory (EPROM or Flash memory), an optical fiber, and a portable compact disk read-only memory (CDROM).

It will be understood that the additive manufacturing system 12 may be any type of additive manufacturing or “3D printing” system such as a sintering, laser melting, laser sintering, extruding, fusing, stereolithography, or laminated object manufacturing system. The additive manufacturing system 12 may also be a hybrid system that combines additive manufacturing with molding, scaffolding, and/or other subtractive manufacturing or assembly techniques.

The powder coating system 14 coats the part 100 in a protective outer coating and broadly includes a primer applicator 32, a powder coating applicator 34, and a curing apparatus 36. The powder coating system 14 may be integral with or separate from the additive manufacturing system 12.

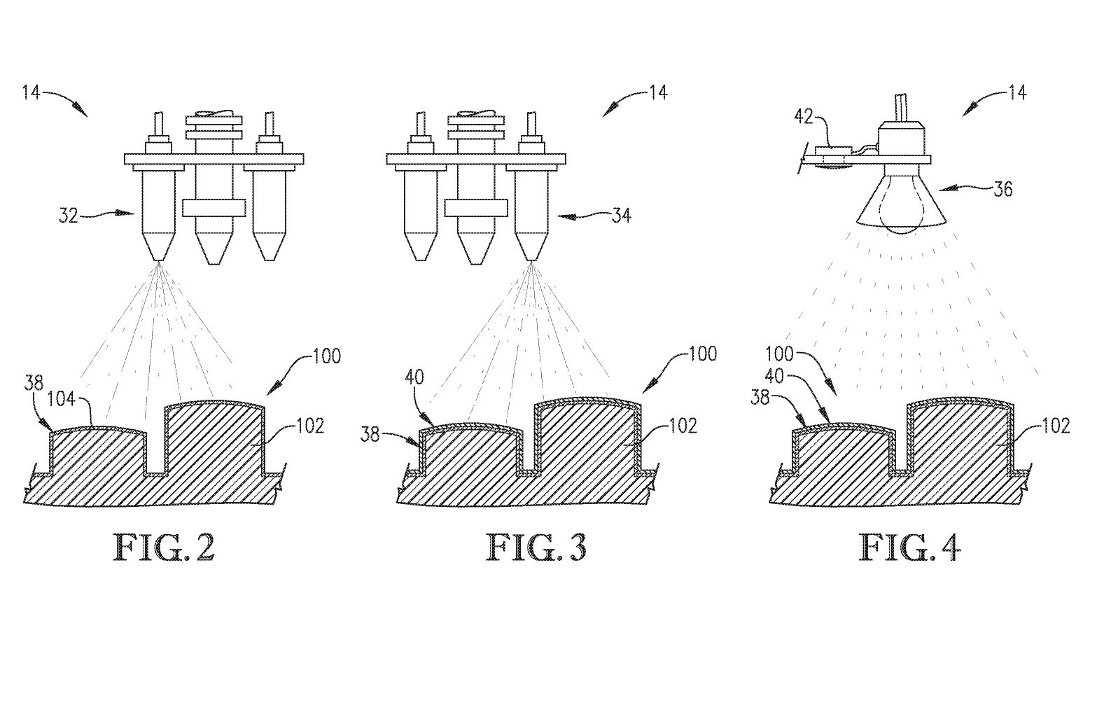

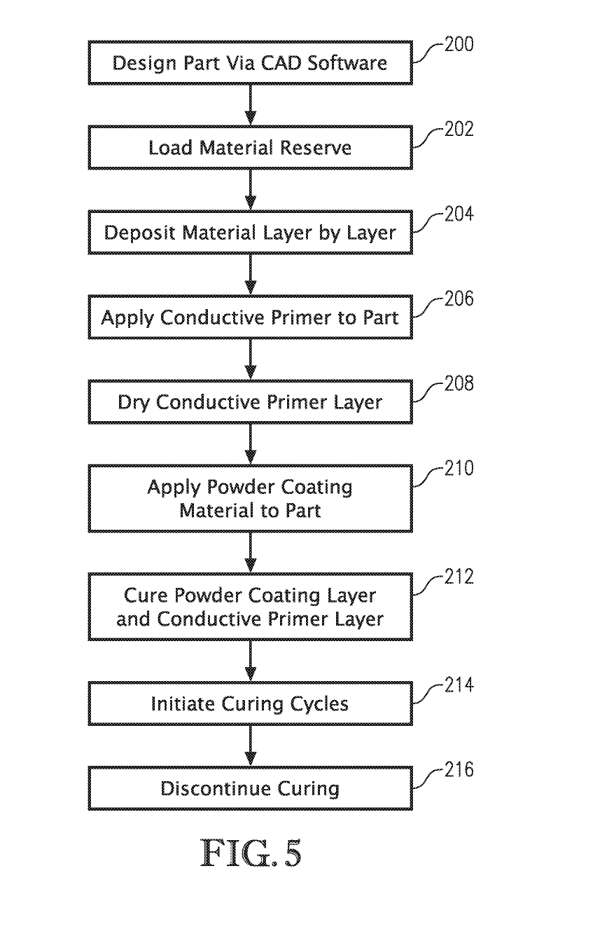

The primer applicator 32 applies a layer of conductive primer 38 (described below) onto an outer surface 104 of the part 100 and may include a nozzle, guide, sprayer, or other similar component, as shown in FIG. 2. The primer applicator 32 may be handheld or part of a robotic assembly. For example, the primer applicator 32 may be integrated with the material applicator 24 of the additive manufacturing system 12.

The conductive primer 38 layer adheres to the outer surface 104 of the core 102 of the part 100 and may include a polyurethane base resin, a surfactant, a conductive component, an inert component, and/or any other suitable ingredients in any suitable ratios and quantities. For example, the conductive primer 38 may be a 3% to 10% primer solution. In one embodiment, the conductive primer 38 may be a 6% primer solution. Any other solution such as 100% primer solutions and pre-mixed solutions may also be used.

The powder coating applicator 34 applies a layer of electrostatically charged powder coating 40 (described below) onto the conductive primer layer 38 and may include a nozzle, guide, sprayer, or other similar component, as shown in FIG. 3. The powder coating applicator 34 may be handheld or part of a robotic assembly. For example, the powder coating applicator 34 may be integrated with the material applicator 24 of the additive manufacturing system 12 and/or the primer applicator 32 of the powder coating system 14.

The electrostatically charged powder coating 40 initially electrostatically adheres to the conductive primer 38 and then chemically adheres to the conductive primer 38 upon curing, as described below. The electrostatically charged powder coating 40 may be one color of a plurality of colors such that the effective color of the part 100 may be selected via the powder coating 40.

The curing apparatus 36 heats the part 100 such that the electrostatically charged powder coating 40 chemically adheres to the conductive primer 38 and may include a curing sensor 42. The curing sensor 42 may be a temperature sensor for sensing a temperature of the part 100 itself or the curing environment around the part 100. The temperature sensor may also be used for ensuring that the core 102 of the part 100 is not subjected to temperatures above its melting point, as described in more detail below. Alternatively, the curing sensor 42 may be configured to directly sense a curing progress of the part 100 via a current transmitted through the powder coating or other similar technique. The sensor 42 may be communicatively coupled to the processor 28 or another similar processor such that the curing apparatus 36 may continue or discontinue curing according to readings from the sensor 42. The curing apparatus 36 may be an infrared lamp (as shown in FIG. 4), an oven, or other similar heating device and may be separate from or integral with the additive manufacturing system 12 and/or the other components of the powder coating system 14.

It will be understood that the additive manufacturing system 12 and powder coating system 14 may be integrated together or entirely separate and independently-operating systems. For example, the additive manufacturing system 12 and powder coating system 14 may each be stand-alone systems.

Use of the additive manufacturing and powder coating system 10 will now be described in more detail. First, a computer aided design of the part 100 may be generated via additive manufacturing design software, as shown in block 200. The design may take into account manufacturer's specifications of the additive manufacturing system 12, powder coating system 14, conductive primer 38, and powder coating 40.

The non-conductive low melting point material 30 may then be inserted in or positioned on the material reserve 20 of the additive manufacturing system 12, as shown in block 202. For example, a spool of the non-conductive low melting point material 30 may be loaded onto the additive manufacturing system 12.

The non-conductive low melting point material 30 may then be deposited onto the support surface 18 via the material applicator 24 in successive layers according to the computer-aided design of the part 100, as shown in block 204. To that end, activation of horizontally oriented motors in various amounts allows for diagonal movement and curved movement of the material applicator 24. Activation of a vertically oriented motor may be used for relocating the material applicator 24 without depositing material and/or raising the material applicator 24 for creation of a new layer (see motors 26, above).

A conductive primer may then be sprayed or deposited onto the part 100 via the primer applicator 32 so as to form a conductive primer layer 38, as shown in block 206. This may be performed while the part 100 remains positioned on the support surface 18 or remotely from the additive manufacturing system 12.

The conductive primer layer 38 may then be air dried, as shown in block 208. Duration of the air drying may be dependent on the makeup of the conductive primer layer 38 and the size and geometry of the part 100. In one embodiment, the conductive primer layer 38 may be air dried for approximately twenty-four hours.

The material used for forming the powder coating 40 may be selected according to a desired part color, and optionally other characteristics, and then sprayed or deposited onto the layer of conductive primer 38 via the powder coating applicator 34, as shown in block 210. The powder coating applicator 34 may electrostatically charge the powder coating 40 as it is emitted from the powder coating applicator 34 such that the powder coating 40 electrostatically bonds to the conductive primer 38.

The powder coating 40 and the conductive primer layer 38 may then be cured, as shown in block 212. As described above, the curing apparatus may emit infrared light, heat, or any other suitable curing effector. For example, an infrared lamp may shine infrared light onto the part 100 until the powder coating 40 and the conductive primer layer 38 are chemically bonded together.

The curing apparatus 36 may ensure that the core 102 of the part 100 is not subjected to temperatures above the melting point of the non-conductive low melting point material 30 during curing by initiating curing cycles, as shown in block 214. For example, the curing apparatus 36 may be repeatedly turned on and off or opened and closed at two pulses or cycles per minute. Alternatively, a shutter of the curing apparatus 36 may be opened or closed or fan blades may be rotated between the curing apparatus 36 and the part 100 at two activations or rotations per minute such that pulsed or cycled heat or light reaches the part 100. In yet another embodiment, the part 100 may be rotated (e.g., at two rotations per minute) such that portions of the part 100 are exposed to the heat or light in a pulsed manner. In another embodiment, the part 100 may be removed from and returned to the curing apparatus 36. It will be understood that the pulses, activations, rotations, or other cyclic actions effecting the pulsed or cyclic heating pattern may be performed at any other rate such as between 1 cycle per minute and 10 cycles per minute. The cyclic heating pattern allows the electrostatically charged powder coating 40 to be heated up sufficiently for curing without the core 102 of the part 100 being heated up to a temperature that results in the core 102 melting or being structurally compromised. This does not negatively affect the curing of the electrostatically charged powder coating 40 because powder coating does not need to be cured continuously. In one embodiment, the electrostatically charged powder coating 40 may be cured at 275 degrees Fahrenheit while the core 102 of the part 100 may remain below 180 degrees Fahrenheit. The processor 28 may end a curing cycle when the temperature of the electrostatically charged powder coating 40 nears or reaches 275 degrees, when the core 102 of the part 100 nears or reaches 180 degrees, or when the air around part 100 reaches a predetermined temperature, as sensed by the curing sensor 42. The processor 28 may initiate a new curing cycle when the temperature of one of the above elements drops to another predetermined temperature.

The curing apparatus 36 may discontinue curing when the powder coating 40 and conductive primer layer 38 have cured a predetermined amount, as shown in block 216. To that end, curing may be discontinued after a predetermined amount of time or after a predetermined temperature has been reached. This ensures uniformity and consistency between curings.

The above-described additive manufacturing and powder coating system 10 provides several advantages over conventional systems. For example, parts formed of non-conductive and/or low melting point material via additive manufacturing may be powder coated via the additive manufacturing and powder coating system 10. The powder coating may be cured without melting the non-conductive low melting point material or subjecting it to structurally-compromising temperatures. The curing apparatus 36 may self-monitor the curing process to ensure that the parts are not subjected to melting or structurally-compromising temperatures via the sensor 42 and may uniformly and consistently cure parts. The powder coating may protect the part from abrasions and ultraviolet degradation. The powder coating may greatly expand the number of colors available for parts formed via additive manufacturing.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A system for powder coating a part core formed via additive manufacturing, the system comprising:
a primer applicator configured to apply a layer of conductive primer onto an outer surface of the core of the part;
a powder coating applicator configured to apply a layer of a electrostatically charged powder coating onto the conductive primer layer such that the powder coating electrostatically bonds to the conductive primer layer; and
a curing apparatus configured to cure the powder coating and the conductive primer while retaining a temperature of the core of the part below a melting point of the non-conductive low melting point material.

2. The system of claim 1, wherein the curing apparatus is configured to retain the temperature of the core of the part below the melting point of the non-conductive low melting point material by heating the power coating and the conductive primer in cycles.

3. The system of claim 2, wherein the curing apparatus is an infrared lamp configured to be pulsed on and off.

4. The system of claim 2, wherein the curing apparatus is an oven configured to be cycled on and off.

5. The system of claim 2, wherein the curing apparatus comprises a temperature sensor configured to sense when the temperature of the core of the part is nearing the melting point of the non-conducive low melting point material.

6. The system of claim 1, wherein the non-conductive low melting point material is a polymer.

7. The system of claim 1, wherein the powder coating is configured to be selected from a plurality of powder coatings each being a different color.

8. The system of claim 1, wherein the powder coating has a greater resistance to ultraviolet degradation than the non-conductive low melting point material such that the powder coating protects the part from ultraviolet degradation.

9. The system of claim 1, wherein the powder coating has a greater resistance to abrasion than the non-conductive low melting point material such that the powder coating protects the part from abrasions.

10. The system of claim 1, wherein the primer applicator is configured to spray the layer of conductive primer onto the core of the part and the powder coating applicator is configured to spray the layer of electrostatically charged powder coating onto the layer of conductive primer.

11. A method of powder coating a part core, the method comprising the steps of:
providing a supply of non-conductive low melting point material;
depositing some of the low melting point material in layers according to a computer-aided design of the part so as to create the core of the part via additive manufacturing;
applying a layer of conductive primer onto the core of the part;
air drying the conductive primer;
applying a layer of electrostatically charged powder coating onto the conductive primer layer such that the powder coating electrostatically bonds to the conductive primer layer; and
curing the powder coating while retaining the core of the part at a temperature below its melting point.

12. The method of claim 11, wherein the step of curing the powder coating includes the steps of temporarily suspending curing when the temperature of the core of the part nears the melting point of the non-conductive low melting point material and reinitiating curing when the temperature of the core of the part is no longer near the melting point.

13. The method of claim 12, further comprising the step of monitoring the temperature of the core of the part via a temperature sensor.

14. The method of claim 11, wherein the non-conductive low melting point material is a polymer.

15. The method of claim 11, wherein the step of air drying the conductive primer includes air drying the conductive primer for approximately twenty-four hours.

16. The method of claim 11, wherein the step of curing the powder coating includes curing the powder coating via infrared light.

17. The method of claim 11, wherein the step of curing the powder coating includes heating the part in an oven.

18. The method of claim 11, further comprising the step of selecting the powder coating from a plurality of powder coatings each being a different color.

19. The method of claim 11, wherein the step of applying the layer of conductive primer onto the core of the part includes spraying the conductive primer and the step of applying the layer of powder coating onto the conductive primer includes spraying the powder coating.

20. A method of powder coating a part core, the method comprising the steps of:
generating a computer-aided design of the part;
providing a supply of non-conductive low melting point polymer from a plurality of powder coatings each being a different color;
depositing some of the low melting point polymer in layers according to the computer-aided design of the part so as to create the core of the part via additive manufacturing;
spraying a layer of conductive primer onto the core of the part;
air drying the conductive primer for approximately twenty-four hours;
spraying a layer of charged powder coating onto the conductive primer layer such that the powder coating electrostatically bonds to the conductive primer layer; and
curing the powder coating by initiating heating cycles such that the powder coating is cured without a temperature of the core of the part reaching a melting point of the core of the part.
